(19) United States
(12) Patent Application Publication
(10) Pub. No.: US 2012/0233066 A1
(43) Pub. Date: Sep. 13, 2012

(54) SYSTEM METHOD AND COMPUTER PROGRAM PRODUCT FOR MOBILE FINANCIAL TRANSACTIONS

(76) Inventor: Suresh Vallabhaneni, San Ramon, CA (US)

(21) Appl. No.: 13/042,398

(22) Filed: Mar. 7, 2011

(51) Int. Cl. G06Q 40/00

(52) U.S. Cl. 705/40; 705/39

(57) ABSTRACT

A system, method and computer program product includes a mobile computing device. A mobile computing device is configured for communicating over a network region and a global network. A server is configured for receiving and processing financial transaction information, performing financial transactions and receiving results of performed financial transactions. A mobile client executes on the mobile computing device and instructs the mobile computing device. The mobile computing device presents a plurality of contacts for selection. The mobile computing device presents a plurality of financial transactions available for a selected contact. The mobile computing device presents a plurality of payment instruments available for a selected financial transaction. The mobile computing device communicates to the server information associated with the selected contact, the selected financial transaction and the selected payment instrument. The mobile computing device receives results of the selected financial transaction from the sever and displays the results for the user.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the field of mobile computing applications supported via networked application websites. More particularly, the invention relates to providing financial transaction applications associated with mobile computing devices via networked application websites.

### BACKGROUND OF THE INVENTION

Financial transactions using conventional methods (e.g. credit cards, debit cards, gift cards, etc.) are susceptible to compromise from external entities (e.g. hackers, computer viruses, computer spyware, etc.). Additionally, conventional methods for performing financial transactions are limited with respect to entities which may perform transactions. For example, conventional credit card transactions are not easily performed between individuals. In view of the foregoing, there is a need for improved techniques for providing applications for performing financial transactions via mobile computing devices.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram depicting a conventional client/server communication system;

FIG. 2 presents an illustration of an example Mobile Financial Transaction (MFT) system, in accordance with an embodiment of the present invention;

FIG. 3 presents a flow chart illustrating an exemplary method for interaction with the elements of MFT system as described with reference to FIG. 2, in accordance with an embodiment of the present invention; and

FIG. 4 illustrates a typical computer system that, when appropriately configured or designed, may serve as a computer system for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, a system method and computer program product for mobile financial transactions is presented.

In one embodiment a system includes a mobile computing device configured to be operable for communicating over a network region and a global network. A server is configured to be operable for communicating with the mobile computing device and the network region over the global network. The server is configured to be operable for receiving and processing financial transaction information, performing financial transactions and receiving results of performed financial transactions. A mobile client executes on the mobile computing device and is operable for instructing the mobile computing device to present a plurality of contacts available for a user to select at least a one of the plurality of contacts with which to commence a financial transaction where the contacts are stored in the mobile computing device. The mobile client is operable for instructing the mobile computing device to present a plurality of financial transactions available for a selected contact for the user to select a one of the plurality of financial transactions where the plurality of financial transactions are stored in the mobile computing device. The mobile client is operable for instructing the mobile computing device to present a plurality of payment instruments available for a selected financial transaction for the user to select a one of the plurality of payment instruments where the plurality of payment instruments are stored in a mobile wallet in the mobile computing device. The mobile client is operable for instructing the mobile computing device to communicate to the server at least information associated with the selected contact, the selected financial transaction and the selected payment instrument. The mobile client is operable for instructing the mobile computing device to receive results of the selected financial transaction from the sever and display the results for the user. In another embodiment the plurality of contacts comprises contact information for public and private entities. In yet another embodiment the entities comprises individuals and organizations. In still another embodiment at least one of the contacts comprises an email address restricted to financial transactions. In another embodiment the mobile wallet comprises storage for payment instruments comprising electronic versions of credit cards, debit cards, gift cards, prepaid cards, flexible spending account cards and payment providers. In yet another embodiment one or more of the payment instruments comprises an electronic version of a card with identifying information that changes periodically via synchronization with an associated financial establishment. In still another embodiment the mobile client is further operable for instructing the mobile computing device to communicate with a mobile gift store when the user selects a contact to receive a gift. In another embodiment the mobile computing device is further configured to be operable to store a contact obtained from communication with a local entity on the network region where the obtained contact is only available for financial transactions when the mobile computing device is able to communicate with the local entity. In yet another embodiment the obtained contact is removed from storage when communication with the local entity is unavailable. In still another embodiment the mobile client is further operable for instructing the mobile computing device to receive one or more bills for payment by the user. In another embodiment the user selects a plurality of contacts with which to commence a financial transaction.

In another embodiment a system includes means for mobile computing and communicating over a network region and a global network. Included is means for receiving and processing financial transaction information, performing financial transactions and receiving results of performed financial transactions, the receiving and processing means communicating, over the global network, with the mobile computing and communicating means and the network region. Included is means for instructing the mobile computing and communicating means to present a plurality of contacts available for a user to select at least a one of the plurality of contacts with which to commence a financial transaction where the contacts are stored in the mobile computing and communicating means. The instructing means instructs the mobile computing and communicating means to present a plurality of financial transactions available for a selected contact for the user to select a one of the plurality of financial transactions where the plurality of financial transactions are stored in the mobile computing and communicating means. The instructing means instructs the mobile computing and communicating means to present a plurality of payment instruments available for a selected financial transaction for the user to select a one of the plurality of payment instruments where the plurality of payment instruments are stored in a mobile wallet in the mobile computing and communicating means. The instructing means instructs the mobile computing and communicating means to communicate to the receiving and processing means at least information associated with the selected contact, the selected financial transaction and the selected payment instrument. The instructing means instructs the mobile computing and communicating means to receive results of the selected financial transaction from the receiving and processing means and display the results for the user.

In another embodiment a method includes the steps of a mobile client communicating with a network region and a global network. The mobile client presents a plurality of contacts available for a user to select at least a one of the plurality of contacts with which to commence a financial transaction. The contacts are stored in a mobile computing device. The mobile client presents a plurality of financial transactions available for a selected contact for the user to select a one of the plurality of financial transactions. The plurality of financial transactions is stored in the mobile computing device. The mobile client presents a plurality of payment instruments available for a selected financial transaction for the user to select a one of the plurality of payment instruments. The plurality of payment instruments is stored in a mobile wallet in the mobile computing device. The mobile client communicates with a server in communication with the global network. The mobile client transmits at least information associated with the selected contact, the selected financial transaction and the selected payment instrument to the server where the server receives and processes the information, performs the selected financial transaction, receives results of the selected financial transaction from the selected contact, processes the results and transmits the results to the mobile client. The mobile client receives the results from the sever. The mobile client displays the results for the user. In another embodiment the plurality of contacts comprises contact information for public and private entities. In yet another embodiment the entities comprises individuals and organizations. In still another embodiment at least one of the contacts comprises an email address restricted to financial transactions. In another embodiment the mobile wallet comprises storage for payment instruments comprising electronic versions of credit cards, debit cards, gift cards, prepaid cards, flexible spending account cards and payment providers. In yet another embodiment one or more of the payment instruments comprises an electronic version of a card with identifying information that changes periodically via synchronization with an associated financial establishment. Still another embodiment further includes the step of the mobile client communicating with a mobile gift store when the user selects a contact to receive a gift. In another embodiment the mobile computing device is configured to be operable to store a contact obtained from communication with a local entity on the network region where the obtained contact is only available for financial transactions when the mobile computing device is able to communicate with the local entity. In yet another embodiment the obtained contact is removed from storage when communication with the local entity is unavailable. Still another embodiment further includes the step of the mobile client receiving one or more bills for payment by the user. In another embodiment the user selects a plurality of contacts with which to commence a financial transaction.

In another embodiment a method includes steps for communicating with a network region and a global network. Included are steps for receiving one or more bills for payment by a user. Included are steps for presenting a plurality of contacts available for the user to select at least a one of the plurality of contacts with which to commence a financial transaction. Included are steps for presenting a plurality of financial transactions available for a selected contact for the user to select a one. Included are steps for presenting a plurality of payment instruments available for a selected financial transaction for the user to select a one. Included are steps for communicating with a mobile gift store when the user selects a contact to receive a gift. Included are steps for communicating with a server in communication with the global network. Included are steps for transmitting information to the server where the server receives and processes the information, performs the selected financial transaction, receives results of the selected financial transaction from the selected contact, processes the results and transmits the results to the mobile client. Included are steps for receiving the results from the sever and steps for displaying the results for the user.

In another embodiment a non-transitory program storage device readable by a machine tangibly embodying a program of instructions executable by the machine to perform a method for mobile financial transactions, includes computer code for communicating with a network region and a global network. Included is computer code for presenting a plurality of contacts available for a user to select at least a one of the plurality of contacts with which to commence a financial transaction. The contacts are stored in a mobile computing device. Included is computer code for presenting a plurality of financial transactions available for a selected contact for the user to select a one of the plurality of financial transactions. The plurality of financial transactions is stored in the mobile computing device. Included is computer code for presenting a plurality of payment instruments available for a selected financial transaction for the user to select a one of the plurality of payment instruments. The plurality of payment instruments is stored in a mobile wallet in the mobile computing device. Included is computer code for communicating with a server in communication with the global network. Included is computer code for transmitting at least information associated with the selected contact, the selected financial transaction and the selected payment instrument to the server where the server receives and processes the information, performs the selected financial transaction, receives results of the selected financial transaction from the selected contact, processes the results and transmits the results. Included is computer code for receiving the results from the sever and computer code for displaying the results for the user. In another embodiment the plurality of contacts comprises contact information for public and private entities. In yet another embodiment the entities comprises individuals and organizations. In still another embodiment at least one of the contacts comprises an email address restricted to financial transactions. In another embodiment the mobile wallet comprises storage for payment instruments comprising electronic versions of credit cards, debit cards, gift cards, prepaid cards, flexible spending account cards and payment providers. In yet another embodiment one or more of the payment instruments comprises an electronic version of a card with identifying information that changes periodically via synchronization with an associated financial establishment. Still another embodiment further includes computer code for communicating with a mobile gift store when the user selects a contact to receive a gift.

In another embodiment the mobile computing device is configured to be operable to store a contact obtained from communication with a local entity on the network region where the obtained contact is only available for financial transactions when the mobile computing device is able to communicate with the local entity. In yet another embodiment the obtained contact is removed from storage when communication with the local entity is unavailable. Still another embodiment further includes computer code for receiving one or more bills for payment by the user. In another embodiment the user selects a plurality of contacts with which to commence a financial transaction.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention will be described which provide means and methods for enabling financial transactions for applications associated with mobile computing devices and supported via networked application websites.

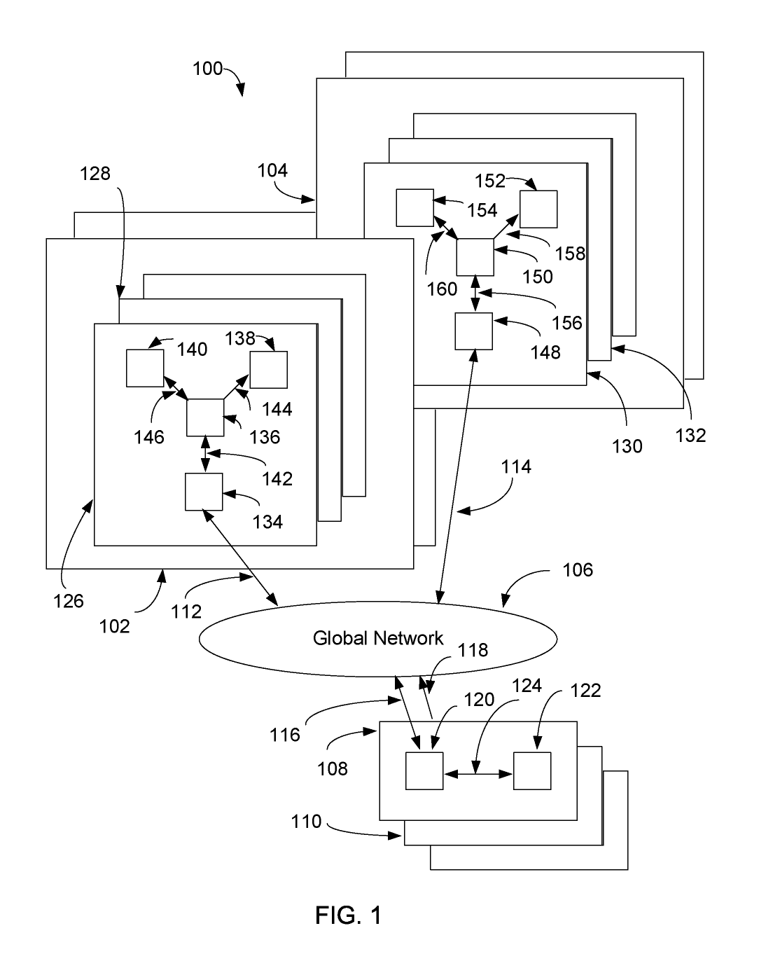

FIG. 1 illustrates a block diagram depicting a conventional client/server communication system.

A communication system 100 includes a multiplicity of networked regions with a sampling of regions denoted as a network region 102 and a network region 104, a global network 106 and a multiplicity of servers with a sampling of servers denoted as a server device 108 and a server device 110.

Network region 102 and network region 104 may operate to represent a network contained within a geographical area or region. Non-limiting examples of representations for the geographical areas for the networked regions may include postal zip codes, telephone area codes, states, counties, cities and countries. Elements within network region 102 and 104 may operate to communicate with external elements within other networked regions or within elements contained within the same network region.

In some implementations, global network 106 may operate as the Internet. It will be understood by those skilled in the art that communication system 100 may take many different forms. Non-limiting examples of forms for communication system 100 include local area networks (LANs), wide area networks (WANs), wired telephone networks, cellular telephone networks or any other network supporting data communication between respective entities via hardwired or wireless communication networks. Global network 106 may operate to transfer information between the various networked elements.

Server device 108 and server device 110 may operate to execute software instructions, store information, support database operations and communicate with other networked elements. Non-limiting examples of software and scripting languages which may be executed on server device 108 and server device 110 include C, C++, C# and Java.

Network region 102 may operate to communicate bi-directionally with global network 106 via a communication channel 112. Network region 104 may operate to communicate bi-directionally with global network 106 via a communication channel 114. Server device 108 may operate to communicate bi-directionally with global network 106 via a communication channel 116. Server device 110 may operate to communicate bi-directionally with global network 106 via a communication channel 118. Network region 102 and 104, global network 106 and server devices 108 and 110 may operate to communicate with each other and with every other networked device located within communication system 100.

Server device 108 includes a networking device 120 and a server 122. Networking device 120 may operate to communicate bi-directionally with global network 106 via communication channel 116 and with server 122 via a communication channel 124. Server 122 may operate to execute software instructions and store information.

Network region 102 includes a multiplicity of clients with a sampling denoted as a client 126 and a client 128. Client 126 includes a networking device 134, a processor 136, a GUI 138 and an interface device 140. Non-limiting examples of devices for GUI 138 include monitors, televisions, cellular telephones, smartphones and PDAs (Personal Digital Assistants). Non-limiting examples of interface device 140 include pointing device, mouse, trackball, scanner and printer. Networking device 134 may communicate bi-directionally with global network 106 via communication channel 112 and with processor 136 via a communication channel 142. GUI 138 may receive information from processor 136 via a communication channel 144 for presentation to a user for viewing. Interface device 140 may operate to send control information to processor 136 and to receive information from processor 136 via a communication channel 146. Network region 104 includes a multiplicity of clients with a sampling denoted as a client 130 and a client 132. Client 130 includes a networking device 148, a processor 150, a GUI 152 and an interface device 154. Non-limiting examples of devices for GUI 138 include monitors, televisions, cellular telephones, smartphones and PDAs (Personal Digital Assistants). Non-limiting examples of interface device 140 include pointing devices, mousse, trackballs, scanners and printers. Networking device 148 may communicate bi-directionally with global network 106 via communication channel 114 and with processor 150 via a communication channel 156. GUI 152 may receive information from processor 150 via a communication channel 158 for presentation to a user for viewing. Interface device 154 may operate to send control information to processor 150 and to receive information from processor 150 via a communication channel 160.

For example, consider the case where a user interfacing with client 126 may want to execute a networked application. A user may enter the IP (Internet Protocol) address for the networked application using interface device 140. The IP address information may be communicated to processor 136 via communication channel 146. Processor 136 may then communicate the IP address information to networking device 134 via communication channel 142. Networking device 134 may then communicate the IP address information to global network 106 via communication channel 112. Global network 106 may then communicate the IP address information to networking device 120 of server device 108 via communication channel 116. Networking device 120 may then communicate the IP address information to server 122 via communication channel 124. Server 122 may receive the IP address information and after processing the IP address information may communicate return information to networking device 120 via communication channel 124. Networking device 120 may communicate the return information to global network 106 via communication channel 116. Global network 106 may communicate the return information to networking device 134 via communication channel 112. Networking device 134 may communicate the return information to processor 136 via communication channel 142. Processor 136 may communicate the return information to GUI 138 via communication channel 144. User may then view the return information on GUI 138.

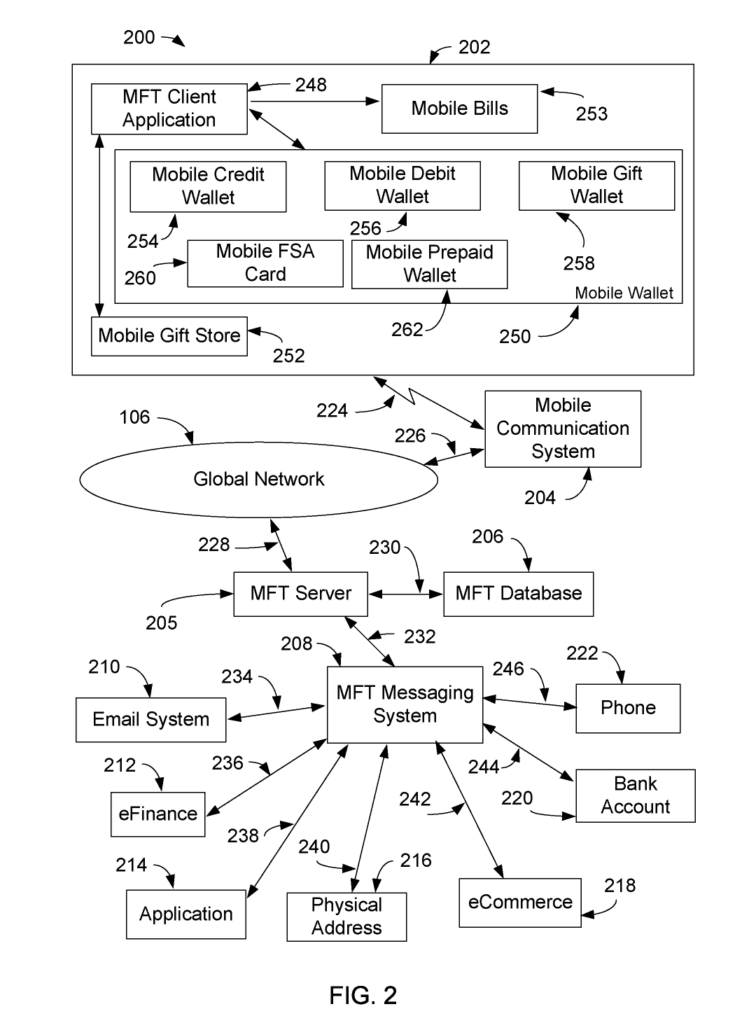

FIG. 2 presents an illustration of an example Mobile Financial Transaction (MFT) system, in accordance with an embodiment of the present invention.

An MFT system 200 includes a mobile computing device 202, global network 106, a mobile communications system 204, a MFT server 205, a MFT database 206, a MFT messaging system 208, an email system 210, an eFinance portion 212, an application portion 214, a physical address portion 216, an eCommerce portion 218, a bank account portion 220, and a phone portion 222.

Elements of FIG. 2 in common with FIG. 1 will not be described with reference to FIG. 2. For elements of FIG. 2 in common with FIG. 1, the reader may reference the previous discussion with reference to FIG. 1.

MFT system 200 may operate to enable a user (not shown) associated with mobile computing device 202 to perform financial transactions. Mobile computing device 202 is typically configured as an MFT client system and the remaining components of MFT system 200 are typically configured as an MFT server system. Non-limiting examples of financial operations supported include transactions for paying, gifting, borrowing, lending or repaying. Furthermore, financial operations may be performed for contacts associated with mobile computing device 202 or contacts associated with devices which mobile computing device 202 may perform communications with. Non-limiting types associated with contacts include phone number, email address, physical address, bank account, application, person, person's name, organization, organization's name and unique identifier. Non-limiting examples of email address include generic email address, PayPal® email address, Facebook® email address and Google Checkout® email address. Non-limiting examples for phone number include phone numbers for individual and organizations. Non-limiting examples associated with bank account include name of bank, routing number and account number. Non-limiting examples associated with unique identifier include unique identifiers for individuals and organizations. Non-limiting examples associated with application type include downloadable applications for a fee. Furthermore, application type includes applications associated as a contact or not associated as a contact.

Mobile computing device 202 may operate to interface with a user for performing conventional operations associated with mobile computing devices in addition to operations associated with performing MFT. Non-limiting examples of devices for mobile computing device 202 include cell phones, mobile phones, smart phones, tablet devices and Personal Digital Assistants (PDAs). Functionality for MFT may be enabled for mobile computing device 202. Non-limiting examples for enabling MFT for mobile computing device 202 include as a downloadable application, as a default application and as an enhanced contacts application. Mobile computing device 202 enabled with MFT may operate to perform financial transactions. Non-limiting examples of methods for performing MFT include selection of a new entity for contact, selection of a previous entity for contact or entry of a new entity enabled for contact. A contactable entity for MFT may be defined as an entity associated with a mobile computing device or an entity with sufficient information as to be contactable by a mobile computing device. Selecting a contact for MFT may correspond with an operation or operations associated with a particular mobile computing device. For example, for an Android® based mobile computing device, selecting a contact for performing financial transactions may be performed by selecting and continuing to select a contact for a certain time period in order to invoke a context menu. Furthermore, for an Android® based mobile computing device, a user may select to perform a right click operation associated with the contact or potential contact and perform financial transactions. As another example for an iPhone® mobile computing device, selecting a contact may be performed by selecting the presented contact association followed by a transition to a subsequent presentation of information. As another example for an iPhone® mobile computing device, capability may be provided for a user to select a contact or entity which may be associated with the contact and further selecting an option (e.g. ‘money’, etc.) with direction provided to another presentation associated with performing financial transactions. Furthermore, similar capability as described previously may be provided for any known device and its associated operating system.

In some embodiments a contactable entity may be another system or application that comes within the range of the mobile computing device 202 such as, but not limited to, entities in network regions 102 and 104. The mobile computing device 202 may communicate using protocols such as, but not limited to, Bluetooth® or Wi-Fi. Such said system or application may request to be added as a contact and may contain information to be contactable such as, but not limited to, email address, phone number or bank account etc. The user of the mobile computing device 202 may choose to accept or reject this contactable entity to be added as a contact type and/or contact either temporarily or permanently.

If the user rejects adding this contact temporarily, the user may be prompted with the same request whenever the system or application comes within the range of the mobile computing device 202. If the user rejects the request permanently, the mobile computing device 202 always blocks the request by the system or application.

If the user accepts the request temporarily, the user may be able to perform the financial transaction capabilities of MFT system 200 on the new contactable entity. Once the user is out of the range of the system or application, the contactable entity may be removed from the mobile computing device 202.

If the user accepts the request permanently, the system or application may be added as a contact on the mobile computing device 202. The user may be able to perform the financial transaction capabilities of MFT system 200 on the new contact. Once the user is out of the range of the system or application, the contact may be in a disabled state. When the mobile computing device 202 is back in the range of the system or application, the contact may be in an enabled state for financial transaction offered by MFT system 200.

Mobile communications system 204 may operate to provide wireless communications between mobile devices and other devices associated with global network 106.

MFT server 205 may operate to execute software instructions, store information, support database operations and communicate with other networked elements. Non-limiting examples of software and scripting languages which may be executed on MFT server 205 include C, C++, C# and Java. Furthermore, MFT server 205 may operate to perform financial transactions associated with MFT system 200.

MFT database 206 may operate for storing and retrieving information associated with MFT operations and maintenance.

MFT messaging system 208 may operate to provide communications between a server and other entities. Non-limiting examples of other entities include email, eFinance, applications, physical address, eCommerce, bank account and phone.

Email system 210 may operate to provide email associated communication and communication for transactions between an entity and MFT messaging system 208.

eFinance portion 212 may operate to provide financial transactions associated with a global network and for transactions between an entity and MFT messaging system 208.

Application portion 214 may operate to provide applications for performing transactions between an entity and MFT messaging system 208.

Physical address portion 216 may operate to provide a location for performing transactions between an entity and MFT messaging system 208.

eCommerce portion 218 may operate to provide eCommerce as well as eCommerce associated transactions between an entity and MFT messaging system 208.

Bank account portion 220 may operate to provide banking services as well as bank account associated transactions between an entity and MFT messaging system 208.

Phone portion 222 may operate to provide phone associated services as well as phone associated transactions between an entity and MFT messaging system 208.

Mobile computing device 202 may operate to communicate bi-directionally with mobile communications system 204 via a wireless communication channel 224.

Mobile communications system 204 may operate to communicate bi-directionally with global network 106 via a communication channel 226. Global network 106 may operate to communicate bi-directionally with MFT server 205 via a communication channel 228. MFT server 205 may operate to communicate bi-directionally with MFT database 206 via a communication channel 230. MFT messaging system 208 may operate to communicate bi-directionally with email system 210 via a communication channel 234, with eFinance portion 212 via a communication channel 236, with application portion 214 via a communication channel 238 with physical address portion 216 via a communication means 240, with eCommerce portion 218 via a communication channel 242, with bank account portion 220 via a communication channel 244 and with phone portion 222 via a communication channel 246.

Furthermore, mobile computing device 202 may operate to communicate bi-directionally via global network 106 with MFT server 205 and MFT messaging system 208 and associated devices.

Applications may be associated with mobile computing device 202. Applications associated with mobile computing device 202 include a MFT client application 248, a mobile wallet 250, a mobile gift store 252 and a mobile bills 253.

MFT client application 248 may perform operations associated with financial transactions. MFT client application 248 may operate to communicate information to MFT server associated with payment information, payee identification information and other associated transaction information. Non-limiting examples for payee identification information include email address, PayPal® associated email address and Google Checkout® associated email address. MFT client application 248 may operate to receive and present information associated with completion of a financial transaction. MFT client application 248 may operate to process registration information for purchase of associated applications. MFT client application 248 may operate to process transactions associated with gift transactions. MFT client application 248 may operate to process transactions associated with loan transactions.

MFT client application 248 may operate to support transactions associated with paying, gifting, borrowing, lending and repaying. For paying, a user may operate to present a payment to an individual or organization. For gifting, a user may operate to present a gift to an individual or organization. As a non-limiting example, organization may include a charity. For borrowing, a user may borrow with a promise to repay from an individual or organization. Loan repayment may require interest or may not require interest. For lending, the user may present a loan to an individual or organization with a condition for repayment. Loan repayment may require interest or may not require interest. For repaying, a user may repay an amount to an individual or organization previously allocated to user.

Mobile wallet 250 may be configured for operation via mobile computing device 202. Mobile wallet 250 may be configurable as a downloaded application, as a default application and as an enhanced contacts application. As a non-limiting example, mobile wallet 250 may operate as an electronic credit card, debit card or gift card as an alternative to conventional physical financial associated cards. Mobile wallet 250 may be configured for virtual entities as represented by eFinance and eCommerce establishments. Non-limiting examples for eFinance and eCommerce establishments include PayPal® and Google Checkout®.

Mobile wallet 250 may be protected by a unique identifier selected and known by user for performing transactions. As an aid for security, user may be required to periodically modify unique identifier. Furthermore, for security reasons, mobile cards associated with mobile wallet 250 may be terminated following a limited number of invalid transactions. Following termination of a mobile card, user may operate to request a replacement mobile card. Furthermore, mobile cards associated with mobile wallet 250 may be terminated following a limited number of invalid attempts to gain access. Security features associated with mobile wallet 250 may be configurable. Non-limiting examples of configurable security features include restricting access to mobile wallet 250, configuring number of invalid attempts associated with termination of a mobile card, restricting access to mobile wallet 250 after a configurable number of invalid attempts to gain access with further termination of mobile card when followed by a number of successive invalid attempts to gain access. Furthermore, following restriction of access to mobile wallet 250, a user may be required to communicate with customer service for user authentication in order to regain access to mobile wallet 250.

A user may initiate mobile wallet 250 by supplying unique identifier and selecting a mobile card for performing a financial transaction. As an aid for increased security, mobile cards may have associated unique identifiers. Furthermore, unique identifiers for mobile cards may be configurable. As a non-limiting example, unique identifiers for mobile cards may be enabled or disabled. Furthermore, unique identifiers required by financial institutions may be transparently stored, retrieved and provided. An electronic image of a mobile card may be presented to a user or presented by user to another entity followed by execution of a financial transaction. Execution of a financial transaction may be considered as similar to the conventional process of swiping a physical card or scanning a coupon.

Mobile gift store 252 may be configured for a mobile device application enabling a user to browse available gifts or gift cards. As a non-limiting example, gift and gift cards associated with mobile gift store 252 may be configured as physical or electronic. Mobile gift store 252 may operate to enable a user to purchase an item via mobile wallet 250 and present the item as a gift to a recipient associated with a mobile computing device.

As an example, a user may select a contact via mobile computing device 202 in order to perform a financial gift transaction. Available options associated with user's mobile wallet 250 may be presented to user. User may select a desired operation for performing a transaction. Furthermore, following the selection, the transaction may be processed via MFT system 200.

Mobile gift store 252 may operate to enable a user to present an item to another individual in order to demonstrate appreciation, affection, love, etc. Many cultures support gifting with clothes, electronics and gift cards as common items for gifts.

Mobile bills 253 may operate to perform operations associated with receiving and paying bills from vendors and other associated merchants.

Mobile wallet 250 includes a mobile credit wallet 254, a mobile debit wallet 256, a mobile gift wallet 258, a mobile Flexible Spending Account (FSA) card 260 and a mobile prepaid wallet 262.

Mobile credit wallet 254 may operate as an alternative to a conventional credit card. A user may receive mobile credit wallet 254 from a financial institution or institutions providing mobile credit transactions. User may be configured for mobile credit wallet 254 following acceptance by a financial institution. Application for mobile credit wallet 254 may be performed in-person, via phone, via Internet or via hard copy. Financial institution may perform identity authentication. The financial institution may configure mobile credit wallet 254 for operation via the phone number associated with mobile computing device 202. The financial institution may communicate to user the information for configuring mobile credit wallet 254 for operation with mobile computing device 202. User may download the information associated with an electronic credit card to mobile credit wallet 254. A unique identifier may be provided by user when requesting electronic credit card which may be required by financial institution in order to configure mobile credit wallet 254 for operation. User may operate to modify unique identification by entering old unique identifier, new unique identifier and confirming new unique identifier. A failure to enter a correct unique identifier after a predetermined number of attempts may operate to terminate operation of the electronic credit card associated with mobile credit wallet 254. Furthermore, following termination of an electronic credit card associated with mobile credit wallet 254, a user may operate to acquire a new electronic credit card from financial institution. For a condition of a lost mobile computing device 202, the electronic credit card associated with mobile credit wallet 254 may be terminated.

Mobile debit wallet 256 may operate as an alternative to a conventional debit card. A user may receive mobile debit wallet 256 from a financial institution or institutions providing mobile debit transactions. User may be configured for mobile debit wallet 256 following acceptance by a financial institution. Application for mobile debit wallet 256 may be performed in-person, via phone, via Internet or via hard copy. Financial institution may perform identity authentication. The financial institution may configure mobile debit wallet 256 for operation via the phone number associated with mobile computing device 202. The financial institution may communicate to user the information for configuring mobile debit wallet 256 for operation with mobile computing device 202. User may download the information associated with an electronic debit card to mobile debit wallet 256. A unique identifier may be provided by user when requesting electronic debit card which may be required by financial institution in order to configure mobile debit wallet 256 for operation. User may operate to modify unique identification by entering old unique identifier, new unique identifier and confirming new unique identifier. A failure to enter a correct unique identifier after a predetermined number of attempts may operate to terminate operation of the electronic debit card associated with mobile debit wallet 256. Furthermore, following termination of an electronic debit card associated with mobile debit wallet 256, a user may operate to acquire a new electronic debit card from financial institution. For a condition of a lost mobile computing device 202, the electronic debit card associated with mobile debit wallet 256 may be terminated.

Mobile cards associated with mobile credit wallet 254 and mobile debit wallet 256 may not be transferable from one mobile device to another mobile computing device. The card number and Card Verification Value (CVV) code associated with a mobile card may change periodically via synchronization with the associated financial establishment for the mobile card. For a lost mobile computing device, a user may operate to terminate a mobile card associated with mobile wallet 250. Non-limiting methods for terminating a mobile card include phone, Internet and text messaging.

Mobile gift wallet 258 may operate as an alternative to a conventional gift card. A user may receive a mobile gift card as a gift from a friend, relative or associate. User may be presented via mobile computing device 202 with a message indicating receipt of a mobile gift card and other information associated with mobile gift card. Non-limiting examples of other information include amount of mobile gift card and expiration date. For mobile computing device 202 with an installed mobile gift wallet 258, user may operate to use received mobile gift card upon initialization and execution of mobile gift wallet 258. For a mobile device with mobile gift wallet 258 not installed, a user may install mobile gift wallet 258 in order to receive and make use of mobile gift card.

Mobile gift cards associated with mobile gift wallet 258 may be transferable from one mobile computing device to another mobile computing device. Furthermore, mobile gift cards may be converted to physical gift cards. Conversion from mobile gift card to physical gift card may be performed with or without a fee.

Mobile FSA card 260 may operate as an alternative to a conventional FSA card. A user may receive mobile FSA card 260 from a financial institution or institutions providing mobile FSA transactions. User may be configured for mobile FSA card 260 following acceptance by a financial institution. Application for mobile FSA card 260 may be performed in-person, via phone, via Internet or via hard copy. Financial institution may perform identity authentication. The financial institution may configure mobile FSA card 260 for operation via the phone number associated with mobile computing device 202. The financial institution may communicate to user the information for configuring mobile FSA card 260 to operate with mobile computing device 202. User may download the information associated with an electronic FSA card to mobile FSA card 260. A unique identifier may be provided by user when requesting electronic FSA card which may be required by financial institution in order to configure mobile FSA card 260 for operation. User may operate to modify unique identification by entering old unique identifier, new unique identifier and confirming new unique identifier. A failure to enter a correct unique identifier after a predetermined number of attempts may operate to terminate operation of the electronic FSA card associated with mobile FSA card 260. Furthermore, following termination of an electronic FSA card associated with mobile FSA card 260, a user may operate to acquire a new electronic FSA card from financial institution. For a condition of a lost mobile computing device 202, the electronic FSA card associated with mobile FSA card 260 may be terminated.

Mobile prepaid wallet 262 may operate as an alternative to a conventional prepaid card. Mobile prepaid wallet 262 may operate as an electronic prepaid card and may be obtained by advancing a payment associated with the electronic prepaid card. An electronic prepaid card may be issued via financial institutions and other entities. Non-limiting examples of financial institutions includes credit card companies, banks and brokerages. A user may receive mobile debit wallet 256 from a financial institution or institutions providing mobile prepaid transactions. User may be configured for mobile prepaid wallet 262 following acceptance by a financial institution. Application for mobile prepaid wallet 262 may be performed in-person, via phone, via Internet or via hard copy. Financial institution may perform identity authentication. The financial institution may configure mobile prepaid wallet 262 for operation via the phone number associated with mobile computing device 202. The financial institution may communicate to user the information for configuring mobile prepaid wallet 262 to operate with mobile computing device 202. User may download the information associated with an electronic prepaid card to mobile prepaid wallet 262. A unique identifier may be provided by user when requesting electronic prepaid card which may be required by financial institution in order to configure mobile prepaid wallet 262 for operation. User may operate to modify unique identification by entering old unique identifier, new unique identifier and confirming new unique identifier. A failure to enter a correct unique identifier after a predetermined number of attempts may operate to terminate operation of the electronic prepaid card associated with mobile prepaid wallet 262. Furthermore, following termination of an electronic prepaid card associated with mobile prepaid wallet 262, a user may operate to acquire a new electronic prepaid card from financial institution. For a condition of lost mobile computing device 202, the electronic prepaid card associated with mobile prepaid wallet 262 may be terminated.

A multiplicity of payment providers may be supported for performing payment transactions. Non-limiting examples of payment providers include PayPal® and Google Checkout®. A user associated with an existing payment provider service may operate to configure mobile wallet 250 for support of transactions associated with payment provider. Following configuration of mobile wallet 250 for supporting transactions of a payment provider, user may operate to perform financial transactions using the payment provider via mobile wallet 250.

A user may select or enter information and select a payment option via mobile computing device 202 associated with a contactable entity in order to perform a payment transaction. A user may be presented a multiplicity of payment options provided via mobile wallet 250. User may select a payment option provided via mobile wallet 250 for performing a payment transaction. Furthermore, the user may be presented promotional offers via mobile wallet 250 during the process of performing a payment transaction. Presentation of promotional offers may be configurable by user, as user may select to enable or disable presentation of promotional offers. Following a user selecting a payment option and selecting to perform a payment transaction, MFT system 200 may process a payment transaction associated with a recipient. Furthermore, recipient may be notified of payment transaction. Payment may be processed via a multiplicity of avenues. Non-limiting examples of avenues supported for payment include email address, PayPal® email address, Google Checkout® email address, phone number, physical address, bank account and application.

For payment transactions associated with an email address, the MFT client application may communicate information to MFT server 205 for processing. Non-limiting examples of information communicated include information associated with payment transaction (e.g. amount, date, item, payee email address, etc.). MFT server 205 may receive and process information and communicate information to recipient of payment transaction. As a non-limiting example, information may be communicated via email. The recipient of the payment transaction may then operate to collect the payment. Non-limiting examples for recipient collecting payment include downloading MFT application and collecting payment via mobile computing device, visiting MFT website and providing banking information followed by MFT system transferring payment to provided bank account, visiting MFT website and providing recipient PayPal® address with payment processed from PayPal® via MFT system 200 and visiting MFT website and providing Google Checkout® email address followed by MFT system 200 transferring payment via Google Checkout® address. As a non-limiting example, for a recipient using MFT website, access may be provided via web browser associated with a computer system or via a mobile browser associated with a mobile computing device. Recipient may be presented with promotional offers and may choose to accept a promotional offer in lieu of payment. Presentation of promotional offers may be configured by user. As a non-limiting example, user may configure to enable or disable presentation of promotional offers. Recipient of payment may operate to exchange payment in lieu of other items. Non-limiting examples of other items include gifts, gifts cards, or other items associated with MFT system 200. Furthermore, recipient may operate to exchange payment in lieu of other items without receiving a promotional offer. Status of payment transaction during transaction processing may be communicated to sender. An initiator of a payment transaction may operate to cancel payment during processing of the payment transaction prior to completion of the payment transaction. For a terminated payment transaction, recipient may receive information communicating a terminated payment transaction.

For payment transactions associated with PayPal® email address, the MFT client application may communicate information to MFT server 205 for processing. Non-limiting examples of information communicated include information associated with payment transaction (e.g. amount, date, item, PayPal® email address, etc.). MFT system 200 may operate to use an associated PayPal® account for performing payment transaction. Furthermore, for performing payment transaction via PayPa1®, MFT system 200 may login to the PayPal® system and make use of the pay functionality associated with PayPal® and the recipient's PayPal® email address for performing a payment transaction. Following completion of a payment transaction, recipient may collect funds associated with payment transaction via PayPa1®. For an invalid PayPal® email address for recipient or an otherwise invalid payment transaction, the payment transaction sender may receive notification information for invalid payment transaction and may receive a refund for failed payment transaction. A sender of a payment transaction may be notified following processing and transaction completion by MFT server 205. Furthermore, notification may be presented to user via MFT client application or via email. Options associated with notification via email may be configured. Non-limiting examples for configuration of email notification include enabled and disabled.

For payment transactions associated with Google Checkout® email address, MFT client application may communicate information to MFT server 205 associated with payment transactions. As a non-limiting example, information communicated includes payment associated information (e.g. amount, Google Checkout® email address, item, date, etc.). MFT system 200 may operate to use the pay functionality and Google Checkout® email address associated with Google Checkout® for performing payment transaction. As a non-limiting example for a method for communication, MFT system 200 may operate to login into Google Checkout® for performing payment transaction. The recipient of the payment transaction may operate to receive funds via Google Checkout®. For a payment transaction attempted for an invalid Google Checkout® account, the sender of the attempted financial transaction may be notified of associated processing errors. Furthermore, funds associated with attempted financial transaction may be refunded to sender of attempted financial transaction. An invalid Google Checkout® email address may be presented as a non-limiting example for an invalid Google Checkout® account. Sender of financial transaction may be notified following successful processing and completion of financial transaction by MFT server 205. Furthermore, as a non-limiting example, financial transaction confirmation message may be presented to user via MFT client application. The receiver associated with the financial transaction may be notified following successful completion of financial transaction. Notification of receiver with financial transaction associated information may be configured. Non-limiting examples for configuration of receiver notification include enabled and not enabled.

For payment transactions associated with phone number, MFT mobile client may communicate payment transaction associated information to MFT server 205. MFT server 205 may communicate a message to the recipient's phone associated with receipt of a payment transaction. Recipient may operate to collect payment via a multiplicity of methods. As non-limiting examples, recipient may download MFT application for collecting payment via mobile computing device and recipient may visit MFT website and provide bank account information for transfer of payment to the provided bank account. Recipient may be presented with promotional offers. Furthermore, recipient may opt to choose to accept promotional offers in lieu of payment. Presentation of promotional offers may be configurable by user, as user may select to enable or disable presentation of promotional offers. Furthermore, recipient may without presentation of a promotional offer, opt to receive gifts, gift cards, or other gift items associated with MFT system 200 in lieu of payment. Sender of payment transaction may be presented with financial transaction status during execution of financial transaction. Sender of financial payment may operate to terminate or cancel payment transaction during execution of financial transaction and prior to completion of financial transaction. For a terminated or canceled attempted financial transaction, a notification may be communicated to recipient with details associated with the terminated transaction.

For payment transactions associated with physical address, MFT mobile client may communicate payment transaction request to MFT server 205 with information associated with payment. MFT server 205 may operate to prepare a check for transfer to physical address via mail. Sender of financial transaction may be notified of status of financial transaction. Non-limiting examples for notification include payment processed, check mailed and check cashed. Sender of financial transaction may opt to terminate financial transaction prior to cashing of check. Recipient of the payment may receive promotional offers. Furthermore, recipient may operate to make use of MFT client system.

For payment transactions associated with bank account, MFT mobile client application may operate to communicate a financial payment transaction request to MFT server 205 with information associated with financial transaction. Non-limiting examples of communicated information include name, address, bank account number, routing number and date. MFT server 205 may operate to perform Automated Clearing House (ACH) transfer request associated with recipient's bank account. MFT server 205 may operate to communicate a confirmation notification to sender with information associated with payment processing. Furthermore, MFT server 205 may communicate a notification to recipient associated with payment processing. Non-limiting examples for notification include email, phone and physical address.

A user may typically download an application for trial prior to purchasing the application. Application may be provided for free trial to an entity with provision for a limited amount of time for trial. Furthermore, application may be provided for free trial to an entity with provision of limited features. An application trial user may opt to purchase the application during the trial period or following completion of the trial period. An application trial user may opt to purchase the application using the MFT client application. MFT mobile client application may communicate a payment transaction request to MFT server 205 with information associated with transaction. MFT client or server application may operate to determine payment information for application and initiate financial transaction based upon payment type configured for the application.

MFT system 200 may operate to provide sender with status information associated with payment transaction. MFT system 200 may be configurable for accepting or rejecting payment transactions. Support may be provided for accepting a payment from an entity with capability for performing communications. MFT system 200 may operate to provide support for reviewing and accepting payment from an entity supporting capability for communicating. MFT system 200 may operate to provide support for rejecting a payment transaction from an entity supporting capability for communicating. MFT system 200 may operate to provide support for accepting partial payment for a financial transaction from an entity supporting capability for communicating. MFT system 200 may operate to provide support for accepting payment for a financial transaction from an entity supporting capability for communications and operating to provide for counter offers for additional payment. MFT system 200 may operate to provide support to block or unblock access for an entity supporting capability for communicating.

A user may select or enter information associated with a contactable entity via mobile computing device 202 in order to activate mobile wallet 250 and mobile gift store 252 for presenting a gift or a gift card. User may browse mobile wallet 250 and select existing gift cards or un-redeemed gifts. For a user not finding a suitable selection from mobile wallet 250 or not having mobile wallet 250 installed, user may be directed to mobile gift store 252. User may browse available gifts and/or gift cards. Furthermore, user may select and purchase a gift and/or gift card via mobile wallet 250. Furthermore, user may gift selected gift and/or gift card to an intended recipient. Recipient may be communicated with notification associated with gift from sender. Furthermore, recipient may redeem gift or gift card via a multiplicity of methods. Non-limiting examples for methods for redeeming gift or gift cards include email, PayPal® and Google Checkout®. MFT client application may communicate information to MFT server 205 associated with gift or gift card and associated method for redemption. MFT server 205 may communicate notification to recipient associated with gift or gift card initiated by user of mobile computing device 202.

A de facto account associated with a provided email address may be created for a gift transaction initiated for a recipient. MFT system 200 may communicate notification information associated with the gift to recipient via email. Furthermore, the amount of information presented to recipient may be configurable. Furthermore, recipient may operate to confirm the receipt of the gift notification. As a non-limiting example, user may confirm receipt of gift notification via selecting a link. Furthermore, user may operate to accept or reject gift transaction. Furthermore, recipient may communicate a comment associated with performing a gift rejection to sender. As a non-limiting example, gift rejection notification and associated comment may be communicated to sender via email. For a gift rejection, funds associated with gift may be refunded to sender. Furthermore, amounts associated with gift rejection may be refunded with a processing fee or without a processing fee. Furthermore, amounts associated with gift rejection may be completely refunded or partially refunded. A user may opt to configure reception of gift rejection messages. Non-limiting examples for configuring reception of gift rejection messages include block, unblock and delete rejection messages. For a user selecting to block or delete gift rejection messages, a standard non-acceptance message may configured for presentation. A user selecting to delete rejection messages may not view previously rejected messages. A user selecting to block rejection messages may be able to configure for unblock and then view previous rejection messages.

A recipient accepting to receive a gift may be requested to provide information for shipment of gift (e.g. name, address, telephone number, etc.). A sender of a gift may be informed of the acceptance of a gift by recipient. Furthermore, sender and recipient may operate to track status of gift (e.g. shipped, in-transit, delivered, etc.). A recipient of a gift offer may be presented and accept promotional offers in lieu of gift. A recipient of a gift offer may be presented and accept items similar or associated with gift in lieu of gift. A recipient of a gift offer may be presented and accept items not associated with gift or random items. Furthermore, alternative items presented to gift recipient may be selected based upon proprietary algorithms associated with MFT system 200.

A de facto account associated with a recipient's email address may be created for a recipient of a gift card. Recipient may be notified of gift card transaction. As a non-limiting example, recipient may be notified of gift card transaction information via email. Non-limiting examples of notification information include amount, date and sender associated information. Presentation of notification information may be configurable. Recipient may select to accept or reject an electronic gift card. As a non-limiting example, recipient may select a link to accept or reject electronic gift card. An electronic gift accepted by a recipient may be added to recipients account (e.g. de facto account). Furthermore, recipient may be notified of information associated with gift card. As a non-limiting example, notification information may be communicated to recipient via email. Recipient may operate to redeem gift card via a multiplicity of methods. Non-limiting examples of methods for redeeming gift card include MFT website, merchant establishments and online merchant establishments. A rejected electronic gift card may be refunded to sender of electronic gift card. Furthermore, refund of electronic gift card may be performed with a fee or without a fee. Furthermore, notification information associated with gift card rejection may be communicated to sender. As a non-limiting example, notification information associated with gift card may be communicated via email. A recipient of a gift card may be presented with an opportunity to create an account profile. Non-limiting examples of information provided for account profile include name, address and phone number. A recipient of a gift card may be presented and accept promotional offers in lieu of a gift card. A recipient of a gift card may be presented and accept items similar or associated with merchant associated with gift card. A recipient of a gift offer may be presented and accept random items. Furthermore, alternative items presented to user gift recipient may be selected based upon proprietary algorithms associated with MFT system 200.

A virtual gift card may operate as an abstract representation for a physical gift card. A virtual gift card may perform certain financial transaction until activation of a physical gift card. Following activation of a physical card, the virtual gift card may not be used for online virtual transactions. A recipient may gain access to virtual gift card via a multiplicity of methods. Non-limiting examples for gaining access to a virtual gift card include downloading/installing MFT application and performing operation via mobile computing device and accessing MFT website and performing operations for activating mobile card for mobile computing device. A virtual gift card recipient may be presented an opportunity to convert virtual gift card into currency. Furthermore, a virtual gift card recipient may be presented with promotional offers as determined by MFT system 200. Furthermore, conversion of virtual gift card into currency or acceptance of promotional offers may be performed with or without a fee. A virtual gift card representing a physical gift card may be considered as redeemed following acceptance of currency, promotional offers, offers to convert to electronic gift cards, offers to convert to physical gift cards or other associated exchange offers. A virtual gift card recipient may operate to select and receive a physical gift card. Furthermore, MFT system 200 may operate to process and deliver physical gift card. Furthermore, as a non-limiting example, MFT system 200 may operate to deliver physical gift card via mail. Prior to delivery of a physical gift card, recipient may convert physical gift card for items as discussed previously. Presentation of promotions and other offerings may be configured. Non-limiting examples of configuration for presentation of promotions include enabled and disabled.

For a gift or gift card associated with a phone number, MFT client application may communicate gift or gift card associated information to MFT server 205. MFT server 205 may perform search operation for provided phone number in order to determine if there is an existing account associated with phone number. For an existing account associated with phone number and an account with an MFT client installed, gift or gift card information may be delivered by MFT server 205 to recipient's MFT client application. For not finding an existing account associated with the phone number, recipient may redeem gift or gift card via a multiplicity of methods. Non-limiting examples for redeeming gift or gift card include downloading/installing MFT client application and receiving gift or gift card via MFT system 200 and visiting MFT website and receiving gift or gift card via MFT system 200. As non-limiting examples, user may visit MFT website via web browser associated with computer or via mobile browser associated with mobile device.

For a gift or gift associated with a physical address, MFT client application may communicate information to MFT server 205 associated with gift or gift card. MFT server 205 may operate to process and mail a gift or gift card to recipient's physical address. Furthermore, information and instructions associated with gift or gift card may be delivered with gift or gift card. As a non-limiting example, instructions may be provided for recipient to return gift or gift card. For an electronic gift card, recipient may be delivered instructions for making use of gift or gift card. Furthermore, instructions may provide recipient with details associated with accessing mobile device and computer Internet-based interfaces and/or applications.

A user may receive a request for a loan transaction from an entity with means for providing contact. User may accept or reject loan transaction request. Loan requestor may select from default loan options or provide unique loan options. Furthermore, a loan requestor may be provided with available options associated with mobile wallet 250. As a non-limiting example, payment options may be provide for a loan request. Loan requestor may select an option or options associated with processing of loan request. Furthermore, processing of loan request may be performed by MFT system 200. Following loan request, loan may be accepted or rejected by a potential supplier of loan.

Potential loan supplier may select to accept or reject loan request. As a non-limiting example, potential loan supplier may accept or reject loan request by selecting a link. For rejection of a loan request, a potential loan supplier may communicate information associated with rejection to loan requestor. Initiator of a rejected loan request may or may not be charged a fee associated with rejection. A user may configure to block/unblock or delete/undelete communicated rejection messages. For a selection to block or delete communicated rejection messages, a standard non-acceptance message may be presented. A user selecting to delete communicated rejection messages may not be able to review previous rejection messages. A user selecting to block communicated rejection messages may be able to view new and previous rejection messages by selecting to unblock rejection messages.

For a loan request with associated email, MFT client application may communicate a message to MFT server 205 with information associated with loan approval. Non-limiting examples of information associated with loan approval include repayment information, loan confirmation information and email address. MFT server 205 may communicate recipient of loan approval information associated with loan approval. Recipient of loan approval may collect funds for loan via a multiplicity of methods. Non-limiting examples of methods for collecting funds include downloading/installing MFT application and receiving funds via a mobile computing device, visiting MFT website and providing bank account information with MFT system 200 transferring loan to bank account, visiting MFT website and providing PayPal® associated information and visiting MFT website and providing Google Checkout® associated information. As a non-limiting example, user may perform access via web browser and an associated computer and via a mobile browser and an associated mobile computing device. Loan recipient may be presented with promotional offers and may choose to accept promotional offers in lieu of receiving loan funds. User may configure presentation of promotional offers. Non-limiting examples for configuring presentation of promotional offers include enable and disable. Loan recipient may choose to accept items associated with MFT system 200 in lieu of receiving loan funds. Furthermore, loan recipient may choose to accept items associated with MFT system 200 without presentation of promotional offers. Loan provider may be presented with status of loan during loan application process. Loan provider may cancel providing loan funds prior to acceptance of loan by loan requestor. For a cancelled loan application, loan requestor may be communicated information associated with loan cancellation.

For a loan request associated with PayPa1®, MFT client application may communicate a message to MFT server 205 with information associated with loan. Non-limiting examples of information communicated include loan approval status, payment information and PayPal® associated information. MFT system 200 may operate to communicate with PayPa1®. Non-limiting examples for MFT system 200 communicating with PayPal® include logging into PayPal® and using pay functionality. Following MFT delivery of funds to PayPa1®, loan recipient may receive funds via PayPa1®. For an invalid loan transaction, loan funds may be returned to loan provider and loan provider may be notified of invalid loan transaction and return of loan funds. As a non-limiting example, an invalid loan transaction may result due to an invalid email address associated with PayPa1®. Loan provider may be notified following transfer of loan funds by MFT server 205 with confirmation message available via MFT client application. Loan recipient may be communicated information associated with confirmation of loan funds transfer. As a non-limiting example, communication of information associated with confirmation of loan funds transfer may be communicated via email. Communication information associated with loan funds transfers may be configurable. Non-limiting examples for configuration of communication information associated with loan funds transfers includes enable and disable.

For a loan request associated with Google Checkout®, MFT client application may communicate a message to MFT server 205 associated with loan. Non-limiting examples of information communicated include loan approval status, payment information and Google Checkout® associated information. MFT system 200 may operate to communicate with Google Checkout®. Non-limiting examples for MFT system 200 communicating with Google Checkout® include logging into Google Checkout® and using pay functionality. Following MFT delivery of funds to Google Checkout®, loan recipient may receive funds via Google Checkout®. For an invalid loan transaction, loan funds may be returned to loan provider and loan provider may be notified of invalid loan transaction and return of loan funds. As a non-limiting example, an invalid loan transaction may result due to an invalid email address associated with Google Checkout®. Loan provider may be notified following transfer of loan funds by MFT server 205 with confirmation message available via MFT client application. Loan recipient may be communicated information associated with confirmation of loan funds transfer. As a non-limiting example, communication of information associated with confirmation of loan funds transfer may be communicated via email. Communication information associated with loan funds transfers may be configurable. Non-limiting examples for configuration of communication information associated with loan funds transfers include enable and disable.

For loan request associated with phone number, MFT mobile client may communicate loan request transaction associated information to MFT server 205. MFT server 205 may communicate a message to the recipient's phone associated with receipt of a loan request transaction. Loan recipient may operate to collect loan funds via a multiplicity of methods. As non-limiting examples, loan recipient may download MFT application for collecting loan funds via mobile computing device, loan recipient may visit MFT website and provide bank account information for transfer of loan funds to the provided bank account, visiting MFT website and receiving loan funds via PayPal® and visiting MFT website and receiving loan funds via Google Checkout®. Recipient may be presented with promotional offers. Furthermore, recipient may opt to choose to accept promotional offers in lieu of receiving loan funds. Presentation of promotional offers may be configurable by user, as user may select to enable or disable presentation of promotional offers. Furthermore, recipient may without presentation of a promotional offer, opt to receive gifts, gift cards, or other gift items associated with MFT system 200 in lieu of receiving loan funds. Sender of payment transaction may be presented with financial transaction status during execution of loan transaction. Sender of financial payment may operate to terminate or cancel loan fund transaction during execution of financial transaction and prior to completion of financial transaction. For a terminated or canceled attempted financial transaction, a notification may be communicated to loan recipient with details associated with the terminated transaction.

For loan request associated with physical address, MFT mobile client may communicate loan funding transaction request to MFT server 205 with information associated with loan funding. MFT server 205 may operate to prepare a check for transfer to physical address via mail. Provider of loan fund transaction may be notified of status of financial transaction. Non-limiting examples for notification include loan processed, check mailed and check cashed. Provider of loan fund financial transaction may opt to terminate financial transaction prior to cashing of check. Recipient of the loan fund may receive promotional offers. Furthermore, recipient may operate to make use of MFT client system.

A user may seek to borrow funds from an entity capable of communications. User may communicate a request to borrow funds from entity capable of communicating. Communications capable entity may accept or reject request for borrowing funds. For an accepted request, funds for borrowing may be transferred. A fund borrower may receive funds via payment options supplied via mobile wallet 250 or by visiting web application associated with MFT system 200.

A recipient of a borrow request may be notified via a multiplicity of methods. Non-limiting examples for notification include email, PayPal® and Google Checkout®. MFT client application may communicate a message to MFT server 205 with information associated with borrowing request. Non-limiting examples of information associated with borrowing request include name, amount, date and email address. MFT server 205 may communicate to the provider of funds for borrowing information associated with the request to borrow. As a non-limiting example, communication associated with request to borrow may be communicated via email. The recipient of the request to borrow funds may accept or reject request to borrow.

If recipient of request to borrow funds rejects borrow request, MFT server 205 may process the rejection and notify borrow requestor of rejection. Requestor of borrow may communicate a custom message associated with request to borrow. Recipient of request to borrow funds may communicate a custom message associated with acceptance or rejection of request to borrow. Requestor of borrow may choose to block reception of custom rejection messages and in the case of a rejection, a generic rejection message may be communicated to borrow requestor. Requestor of borrow may choose to unblock reception of custom rejection messages and view prior communicated custom rejection messages. Requestor of borrow may choose to delete rejection messages. For a selection of choosing to delete rejection messages, requestor of borrow may not view prior communicated custom rejection messages.

For acceptance of a borrow request by recipient, recipient may provide borrow request via a multiplicity of avenues. As a non-limiting example, recipient of borrow request may visit MFT web application or MFT mobile application for downloading/installing MFT client application. Furthermore, recipient of borrow request may be guided by information provided for providing funding of borrow request.

For borrow request associated with phone number, MFT client application may communicate a message to MFT server 205 with information associated with borrow request. Non-limiting examples of information for information associated with borrow request include name, amount, date and phone number. Recipient of the borrow request may accept or reject borrow request.

For a recipient of a borrow request rejecting request, MFT server 205 may process the rejection and communicate reject to initiator of borrow request. Initiator of borrow request may operate to communicate a custom message associated with borrow request. Recipient of borrow request may operate to communicate a custom messaged associated with borrow request. Initiator of borrow request may choose to block custom reject message. Furthermore, MFT server 208 may communicate a generic rejection message for selecting to block custom reject messages. A user may operate to unblock rejection messages and view content of prior communicated rejection messages. A user may select to delete received rejection messages. For a selection to delete rejection messages, a user may not view previously received rejection messages.

A recipient of a borrow request associated with a phone number may pursue a multiplicity of avenues for processing borrow request. As non-limiting examples, recipient may visit a MFT web application, MFT mobile application or may install MFT client application. Furthermore, recipient of borrow request may follow instructions included with information associated with borrow request.

For a borrow request associated with a physical address, MFT client application may communicate a message to MFT server 205 with information associated with borrow request. MFT server 205 may process the received borrow request and process and mail a borrow request to the physical address of the recipient. After receiving borrow request, recipient of borrow request may accept or reject borrow request.

For a recipient selecting to reject a borrow request, a rejection message may be communicated via Internet, via mobile interfaces associated with MFT system 200 or by installing MFT client application. For installation of MFT client application, MFT server 205 may process the rejection and inform borrow requestor of rejection. A borrow requestor may communicate a custom message associated with borrow request. Recipient of borrow request may communicate a custom message associated with borrow request. A user may choose to block a custom rejection message. For a blocked custom rejection message, MFT server 205 may communicate a generic rejection message to a user. A user may operate to unblock rejection messages and view previously communicated rejection messages. A user may select to delete rejection messages. For a selection of deleting rejection messages, prior communicated rejection messages may not be viewed.

For a recipient of a borrow request selecting to accept the borrow request, recipient of borrow request may process borrow request via several avenues. Recipient of borrow request may visit MFT web application, MFT mobile application or installing MFT client application for performing borrow request. Furthermore, recipient of borrow request may follow instructions associated with request for funding borrow request. Furthermore, recipient of borrow request may select to provide funds via check.

A user borrowing funds from a communication enabled entity may operate to repay borrowed funds via MFT system 200. MFT system 200 may operate to present a pending payment and associated details for borrowed funds. Presentation of pending payment may be configured by user. Non-limiting examples for configuration of pending payment include enable and disable. A user may be prompted via mobile wallet 250 to select a payment option for a repayment transaction. User may select option for repayment and proceed with repayment transaction. Following a repayment transaction, the pending balance status, viewable by borrower and fund provider, may be updated.

A recipient of a repayment transaction may be notified of the repayment transaction. Execution of repayment transaction may be processed via a multiplicity of avenues. Non-limiting examples of avenues for performing repayment transaction include email, PayPa1®, Google Checkout®, phone number, physical address, bank account and application.

For repayment associated with email address, the MFT client application may communicate information to MFT server 205 for processing. Non-limiting examples of information communicated include information associated with repayment transaction (e.g. amount, date, item, payee email address, etc.). MFT server 205 may receive and process information and communicate information to recipient of repayment transaction. As a non-limiting example, information may be communicated via email. The recipient of the repayment transaction may then operate to collect the repayment. Non-limiting examples for recipient collecting repayment include downloading MFT application and collecting repayment via mobile computing device, visiting MFT website and providing banking information followed by MFT system transferring repayment to provided bank account, visiting MFT website and providing recipient PayPal® address with repayment processed from PayPal® via MFT system 200 and visiting MFT website and providing Google Checkout® email address followed by MFT system 200 transferring repayment via Google Checkout® address. As a non-limiting example, for a recipient using MFT website, access may be provided via web browser associated with a computer system or via a mobile browser associated with a mobile computing device. Recipient may be presented with promotional offers and may choose to accept a promotional offer in lieu of repayment. Presentation of promotional offers may be configured by user. As a non-limiting example, user may configure to enable or disable presentation of promotional offers. Recipient of repayment may operate to exchange repayment in lieu of other items. Non-limiting examples of other items include gifts, gifts cards, or other items associated with MFT system 200. Furthermore, recipient may operate to exchange repayment in lieu of other items without receiving a promotional offer. Sender may be communicated status of repayment transaction during transaction processing. An initiator of a repayment transaction may operate to cancel repayment during processing of the repayment transaction prior to completion of the repayment transaction. For a terminated repayment transaction, recipient may receive information communicating a terminated repayment transaction.

For repayment associated with PayPa1®, the MFT client application may communicate information to MFT server 205 for processing. Non-limiting examples of information communicated include information associated with repayment transaction (e.g. amount, date, PayPal® email address, etc.). MFT system 200 may operate to use an associated PayPal® account for performing repayment transaction. Furthermore, for performing repayment transaction via PayPa1®, MFT system 200 may login to the PayPal® system and make use of the pay functionality associated with PayPal® and the recipient's PayPal® email address for performing a repayment transaction. Following completion of a repayment transaction, recipient may collect funds associated with repayment transaction via PayPa1®. For an invalid PayPal® email address for recipient or an otherwise invalid repayment transaction, the repayment transaction sender may receive notification information for invalid repayment transaction and may receive a refund for failed repayment transaction. A sender of a repayment transaction may be notified following processing and transaction completion by MFT server 205. Furthermore, notification may be presented to user via MFT client application or via email. Options associated with notification via email may be configured. Non-limiting examples for configuration of email notification include enabled or disabled.

For repayment associated with Google Checkout®, MFT client application may communicate information to MFT server 205 associated with repayment transactions. Non-limiting examples of information communicated include information associated with repayment (e.g. amount, Google Checkout® email address date, etc.). MFT system 200 may operate to use the pay functionality and Google Checkout® email address associated with Google Checkout® for performing repayment transaction. As a non-limiting example of a method for communication, MFT system 200 may operate to login into Google Checkout® for performing repayment transaction. The recipient of the repayment transaction may operate to receive funds via Google Checkout®. For a repayment transaction attempted for an invalid Google Checkout® account, the sender of the attempted financial transaction may be notified of associated processing errors. Furthermore, funds associated with attempted financial transaction may be refunded to sender of attempted financial transaction. An invalid Google Checkout® email address may be presented as a non-limiting example for an invalid Google Checkout® account. Sender of financial transaction may be notified following successful processing and completion of financial transaction by MFT server 205. Furthermore, as a non-limiting example, financial transaction confirmation message may be presented to user via MFT client application. The recipient associated with the financial transaction may be notified following successful completion of financial transaction. Notification of recipient associated with financial transaction may be configured. Non-limiting examples for configuration of recipient notification include enabled and not-enabled.

For repayment associated with phone number, MFT mobile client may communicate repayment transaction associated information to MFT server 205. MFT server 205 may communicate a message to the recipient's phone associated with receipt of a repayment transaction. Recipient may operate to collect repayment via a multiplicity of methods. As non-limiting examples, recipient may download MFT application for collecting repayment via mobile computing device and recipient may visit MFT website and provide bank account information for transfer of repayment to the provided bank account. Recipient may be presented with promotional offers. Furthermore, recipient may opt to choose to accept promotional offers in lieu of repayment. Presentation of promotional offers may be configurable by user, as user may select to enable or disable presentation of promotional offers. Furthermore, recipient may without presentation of a promotional offer, opt to receive gifts, gift cards, or other gift items associated with MFT system 200 in lieu of repayment. Sender of repayment transaction may be presented with financial transaction status during execution of financial transaction. Sender of financial payment may operate to terminate or cancel repayment transaction during execution of financial transaction and prior to completion of financial transaction. For a terminated or canceled attempted financial transaction, a notification may be communicated to recipient with details associated with the terminated transaction.

For repayment associated with physical address, MFT mobile client may communicate repayment transaction request to MFT server 205 with information associated with repayment. MFT server 205 may operate to prepare a check for transfer to physical address via mail. Sender of financial transaction may be notified of status of financial transaction. Non-limiting examples for notification include repayment processed, check mailed and check cashed. Sender of financial transaction may opt to terminate financial transaction prior to cashing of check. Recipient of the repayment may receive promotional offers. Furthermore, recipient may operate to make use of MFT client system.

For repayment associated with bank account, MFT mobile client application may operate to communicate a financial repayment transaction request to MFT server 205 with information associated with financial transaction. Non-limiting examples of communicated information include name, address, bank account number, routing number and date. MFT server 205 may operate to perform Automated Clearing House (ACH) transfer request associated with recipient's bank account. MFT server 205 may operate to communicate a confirmation notification to sender with information associated with repayment processing. Furthermore, MFT server 205 may communicate a notification to recipient associated with repayment processing. Non-limiting examples for notification include email, phone and physical address.

For a repayment associated with an application, MFT mobile client application may communicate a repayment request to MFT server 205 with information associated with repayment. MFT client or server may search for payment information associated with the application and may process the repayment based upon the repayment type configured for the application.

A user receiving a service or product associated with a vendor or merchant may subscribe for mobile bill 253 with the vendor or merchant. Subscribing for mobile bill 253 may be performed via a multiplicity of avenues. Non-limiting examples for avenues for subscribing to mobile bill 253 include merchant website, hard-copy, mobile device. Furthermore, a user may browse or search for vendors supporting mobile bill 253 via MFT system 200. Furthermore, subscription to mobile bill 253 may be performed via mobile computing device 202. User may receive a message via mobile computing device 202 associated with confirming the process for receiving mobile bills 253. To achieve operation for mobile bills 253 may require installation of additional applications. Furthermore, the functionality required for mobile bills 253 may be available by default via the contacts application. Following subscription and installation of mobile bills 253, a merchant may be added as a contact associated with mobile bills 253. A bill from a vendor may be communicated to mobile bills 253 for a registered user for viewing and/or payment. As a non-limiting example, a due date may or may not be associated with a bill. An electronic bill provided via mobile bills 253 may include information associated with a conventional paper bill. Non-limiting examples of information provided via electronic bill include name, address, account number, amount due and due date. For an action to be performed for a vendor or a messaged from a vendor, contact information for the vendor may be presented via a different font, color or texture when hovered over or selected. Font, color or texture for an action associated with a vendor may be configurable. A user may select to send a text message via system 200 when a bill is available. Bill availability may be viewed by a multiplicity of avenues. Non-limiting examples of avenues for viewing bills include Internet enabled computer and Internet enabled mobile computing device. A mobile user may choose to communicate email messages to a multiplicity of email addresses following availability of a bill. A mobile user may choose to send voice messages to multiple phone numbers following availability of a bill. Notification mechanisms for mobile bill 253 may be provided by MFT system 200 and may be configurable by user. A user may select to pay a bill following its availability. A user may select an option to pay by selecting a contact. Following selection of an option to pay, user may be presented with a list of available payment options via mobile wallet 250. User may then select a payment option, followed by an agreement to pay the amount indicated via the bill, followed by a submission of payment request to MFT system 200. MFT system 200 may then proceed to perform payment of the bill for the associated contact. For a user failing to pay a bill by the due date, MFT system 200 may generate a message reminding the user of a past due bill. Furthermore, message reminding user of past due bill may be configurable. Furthermore, a reminder associated with a bill due date may be configured for a time period prior to the bill due date for presentation to user. Contact information associated with a past due bill may be presented via a different font, color and/or texture. Furthermore, presentation (e.g. font, color and/or texture) of contact associated with past due bill may be configurable.

A user may select a contact and view billing information associated with contact. Non-limiting examples of billing information provided include received bills, bill payment history and bill payment history associated with a mobile computing device.

A user may choose to allocate a certain amount to pay for bills from available funds associated with mobile wallet 250. A user may configure funds to set aside for bill payments. Furthermore, MFT system 200 may automatically process the bill payment for associated contacts. A received bill may be processed by MFT system 200 based upon rules configured for payment and payment timelines. For example, a user may configure to pay any bill on the day of receipt or one week prior to the due date.

A user may subscribe for automatic bill payment associated with a credit line for MFT system 200. Furthermore, MFT system 200 may then proceed with automatic payment of bills using preconfigured rules. MFT system 200 may charge a fee for performing bill payments. As non-limiting examples, fee charged may be flat, percentage of bill or time elapsed between a MFT system 200 payment date and a payment date configured by a user.

Mobile system 200 includes the capability to perform secure financial transactions associated with a dynamically generated credit card number, CVV code and/or scan enabled bar code. Furthermore, mobile system 200 includes the capability to use a payment provider (e.g. PayPa1®, Google Checkout®, etc.) as a payment type associated with a mobile computing device in performing financial transactions. Mobile system 200 includes the capability to use a mobile computing device for FSA card transactions. Mobile system 200 includes the capability to select a contact or enter a contact and pay, gift, borrow, lend and/or repay using conventional payment infrastructures. Mobile system 200 includes the capability to receive bill notifications and view status of payments, gifts, etc. Mobile system 200 includes the capability to support financial transactions for individuals, organizations or other entities. Mobile system 200 includes the capability to add a PayPal® account as a contact. Mobile system 200 includes the capability to add a Facebook® account as a contact. Mobile system 200 includes the capability to add a Google Checkout® account as a contact. Mobile system 200 includes the capability to add a physical address as a contact. Mobile system 200 includes the capability to add a bank account as a contact. Mobile system 200 includes the capability to add a gift identification as a contact. Mobile system 200 includes the capability to add a digital identification as a contact. Mobile system 200 includes the capability to configure access for a contact to be used for sending and receiving funds. Mobile system 200 includes the capability to configure access for a contact to be communicated messages associated with paying, gifting, borrowing and lending. Mobile system 200 includes the capability to right click a pointing device and pay using a contact's phone number. Mobile system 200 includes the capability to right click a pointing device and gift using a contact's phone number. Mobile system 200 includes the capability to right click a pointing device and borrow using a contact's phone number. Mobile system 200 includes the capability to right click a pointing device and lend funds using a contact's phone number. Mobile system 200 includes the capability to navigate to a payment presentation and pay using a contact's phone number. Mobile system 200 includes the capability to navigate to a payment presentation and gift using a contact's phone number. Mobile system 200 includes the capability to navigate to a payment presentation and lend using a contact's phone number. Mobile system 200 includes the capability to right click a pointing device and perform a payment using PayPa1®. Mobile system 200 includes the capability to right click a pointing device and perform gifting using PayPa1®. Mobile system 200 includes the capability to right click a pointing device and perform borrowing using PayPa1®. Mobile system 200 includes the capability to right click a pointing device and perform lending using PayPa1®. Mobile system 200 includes the capability to navigate to a payment presentation and perform payment using PayPa1®. Mobile system 200 includes the capability to navigate to a payment presentation and perform gifting using PayPa1®. Mobile system 200 includes the capability to navigate to a payment presentation and perform borrowing using PayPa1®. Mobile system 200 includes the capability to navigate to a payment presentation and perform lending using PayPa1®. Mobile system 200 includes the capability to right click pointing device and perform paying using Google Checkout®. Mobile system 200 includes the capability to right click pointing device and perform gifting using Google Checkout®. Mobile system 200 includes the capability to right click pointing device and perform borrowing using Google Checkout®. Mobile system 200 includes the capability to right click pointing device and perform lending using Google Checkout®. Mobile system 200 includes the capability to navigate to a payment presentation and perform paying via Google Checkout®. Mobile system 200 includes the capability to navigate to a payment presentation and perform gifting via Google Checkout®. Mobile system 200 includes the capability to navigate to a payment presentation and perform borrowing via Google Checkout®. Mobile system 200 includes the capability to navigate to a payment presentation and perform lending via Google Checkout®. Mobile system 200 includes the capability to right click pointing device and perform paying via physical address. Mobile system 200 includes the capability to right click pointing device and perform gifting via physical address. Mobile system 200 includes the capability to right click pointing device and perform borrowing via physical address. Mobile system 200 includes the capability to right click pointing device and perform lending via physical address. Mobile system 200 includes the capability to navigate to payment presentation and perform paying via physical address. Mobile system 200 includes the capability to navigate to payment presentation and perform gifting via physical address. Mobile system 200 includes the capability to navigate to payment presentation and perform borrowing via physical address. Mobile system 200 includes the capability to navigate to payment presentation and perform lending via physical address. Mobile system 200 includes the capability to right click a pointing device and perform a payment using a bank account. Mobile system 200 includes the capability to right click a pointing device and perform gifting using a bank account. Mobile system 200 includes the capability to right click a pointing device and perform borrowing using a bank account. Mobile system 200 includes the capability to right click a pointing device and perform lending using a bank account. Mobile system 200 includes the capability to navigate to a payment presentation and perform payment using a bank account. Mobile system 200 includes the capability to navigate to a payment presentation and perform gifting using a bank account. Mobile system 200 includes the capability to navigate to a payment presentation and perform borrowing using a bank account. Mobile system 200 includes the capability to navigate to a payment presentation and perform lending using a bank account. Mobile system 200 includes the capability to right click a pointing device and perform a payment using a bank account. Mobile system 200 includes the capability to right click a pointing device and perform gifting using a bank account. Mobile system 200 includes the capability to right click a pointing device and perform borrowing using a bank account. Mobile system 200 includes the capability to right click a pointing device and perform lending using a bank account. Mobile system 200 includes the capability to navigate to a payment presentation and perform payment using a bank account. Mobile system 200 includes the capability to navigate to a payment presentation and perform gifting using a bank account. Mobile system 200 includes the capability to navigate to a payment presentation and perform borrowing using a bank account. Mobile system 200 includes the capability to navigate to a payment presentation and perform lending using a bank account. Mobile system 200 includes the capability to right click a pointing device and perform a payment using a bank account. Mobile system 200 includes the capability to right click a pointing device and perform gifting using a bank account. Mobile system 200 includes the capability to right click a pointing device and perform borrowing using a bank account. Mobile system 200 includes the capability to right click a pointing device and perform lending using a bank account. Mobile system 200 includes the capability to navigate to a payment presentation and perform payment using a bank account. Mobile system 200 includes the capability to navigate to a payment presentation and perform gifting using a bank account. Mobile system 200 includes the capability to navigate to a payment presentation and perform borrowing using a bank account. Mobile system 200 includes the capability to navigate to a payment presentation and perform lending using a bank account. Mobile system 200 includes the capability to right click a pointing device and perform a payment using a gift identifier. Mobile system 200 includes the capability to right click a pointing device and perform gifting using a gift identifier. Mobile system 200 includes the capability to right click a pointing device and perform borrowing using a gift identifier. Mobile system 200 includes the capability to right click a pointing device and perform lending using a gift identifier. Mobile system 200 includes the capability to navigate to a payment presentation and perform payment using a gift identifier. Mobile system 200 includes the capability to navigate to a payment presentation and perform gifting using a gift identifier. Mobile system 200 includes the capability to navigate to a payment presentation and perform borrowing using a gift identifier. Mobile system 200 includes the capability to navigate to a payment presentation and perform lending using a gift identifier. Mobile system 200 includes the capability to add a payee as a contact. Mobile system 200 includes the capability to receive bills associated with contacts application. Mobile system 200 includes the capability to perform notification of a due date for a bill associated with a contact. Mobile system 200 includes the capability to perform notification for a payment due date for a bill associated with a contact. Mobile system 200 includes the capability to configure customizable reminders associated with a bill for a contact. Mobile system 200 includes the capability to schedule a payment for a bill via selection of a contact. Mobile system 200 includes the capability to selective add and remove functionality to pay, gift, borrow, lend associated with contact type. Mobile system 200 includes the capability to remove functionality to pay for a bill not due for payment. Mobile system 200 includes the capability to select a multiplicity of contacts for performing payments, gifts, etc.

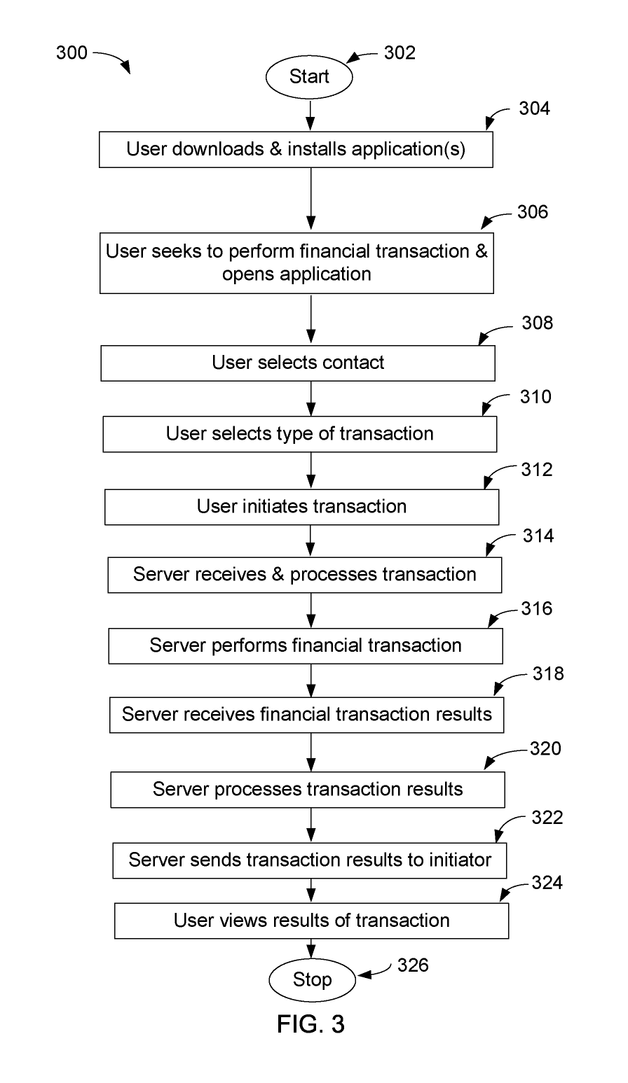

FIG. 3 presents a flow chart illustrating an exemplary method 300 for interaction with the elements of MFT system 200 (FIG. 2), in accordance with an embodiment of the present invention.

For exemplary method 300, the process initiates in a step 302 (FIG. 3).

In a step 304, a user may download and install a MFT application or applications. For example, user may download and install application associated with mobile credit wallet 254 (FIG. 2). Applications may be downloaded and installed from MFT server 205 (FIG. 2) to mobile computing device 202 (FIG. 2) via global network 106 (FIGS. 1-2) and mobile communication system 204 (FIG. 2).

In a step 306, user may seek to perform a financial transaction and may open an application associated with mobile computing device 202 (FIG. 2). For example, user may seek to purchase an item using mobile credit wallet 254 (FIG. 2). User may open mobile credit wallet 254 (FIG. 2) associated with mobile computing device 202 (FIG. 2).

In a step 308, user may select a contact for performing a financial transaction. For example, user may select to purchase an item from a vendor website and may select contact information associated with vendor.

In a step 310, user may select a type of transaction to perform. For example, user may select to perform a credit transaction using mobile credit wallet 254 (FIG. 2).

In a step 312, user may select to initiate a financial transaction. For example, user may select an item to purchase followed by selecting to submit the transaction.

In a step 314, server may receive and process financial transaction. For example, MFT server 205 (FIG. 2) may receive financial transaction submitted via mobile computing device 202 (FIG. 2) and communicated via mobile communication system 204 (FIG. 2) and global network 106 (FIGS. 1-2).

In a step 316, server may perform a financial transaction. For example, MFT server 205 (FIG. 2) may operate to communicate with financial institution representing mobile credit wallet 254 (FIG. 2) for performing a credit transaction and the vendor for purchasing an item. Furthermore, MFT server 205 (FIG. 2) may complete credit transaction for purchase of item from vendor.

In a step 318, server receives information associated with financial transaction. For example, MFT server 205 (FIG. 2) may receive confirmation of purchase of item associated with vendor and confirmation of credit transaction associated with financial institution.

In a step 320, MFT server 205 (FIG. 2) may operate to process financial transaction results. For example, MFT server 205 (FIG. 2) may update MFT database 206 with information associated with financial transaction.

In a step 322, MFT server 205 (FIG. 2) may operate to communicate information associated with transaction results to initiator of financial transaction. For example, MFT server 205 (FIG. 2) may communicate to mobile computing device 202 (FIG. 2) information associated with purchase (e.g. confirmation of purchase, expected ship date, expected delivery date, etc.).

In a step 324, user may view results of financial transaction. For example, user may view financial transaction results via a presentation of information via mobile computing device 202 (FIG. 2).

In a step 326, execution of method 300 may terminate.

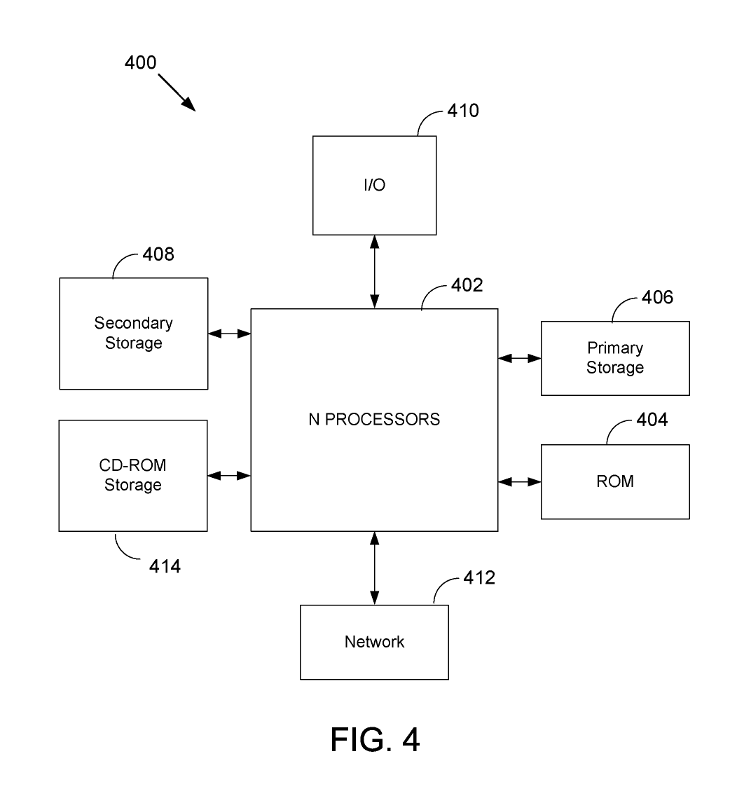

FIG. 4 illustrates a typical computer system that, when appropriately configured or designed, may serve as a computer system 400 for which the present invention may be embodied.

Computer system 400 includes a quantity of processors 402 (also referred to as central processing units, or CPUs) that may be coupled to storage devices including a primary storage 406 (typically a random access memory, or RAM), a primary storage 404 (typically a read only memory, or ROM). CPU 402 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 404 acts to transfer data and instructions uni-directionally to the CPU and primary storage 406 typically may be used to transfer data and instructions in a bi-directional manner. The primary storage devices discussed previously may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and typically may be used as a secondary storage medium such as a hard disk. It will be appreciated that the information retained within mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection shown generally as a network 412, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: MFT server device 205 as described with reference to FIG. 2, global network 106 as described with reference to FIGs.1-2 and portions of the example method as described with reference to FIG. 3.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of performing financial transactions associated with mobile computing devices according to the present invention will be apparent to those skilled in the art. The invention has been described above by way of illustration, and the specific embodiments disclosed are not intended to limit the invention to the particular forms disclosed. For example, the particular implementation of the applications associated with mobile computing devices may vary depending upon the particular type of mobile computing device used. The mobile computing devices described in the foregoing were directed to cellular phone and smart phone implementations; however, similar techniques may be provided by other types of devices such as, but not limited to gaming systems and navigation systems. Implementations of the present invention associated with other types of mobile computing devices are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
a mobile computing device configured to be operable for communicating over a network region and a global network;
a server configured to be operable for communicating with said mobile computing device and the network region over the global network, said server configured to be operable for receiving and processing financial transaction information, performing financial transactions and receiving results of performed financial transactions;
a mobile client executing on said mobile computing device and being operable for instructing said mobile computing device to present a plurality of contacts available for a user to select at least a one of said plurality of contacts with which to commence a financial transaction where said contacts are stored in said mobile computing device, said mobile client being operable for instructing said mobile computing device to present a plurality of financial transactions available for a selected contact for the user to select a one of said plurality of financial transactions where said plurality of financial transactions are stored in said mobile computing device, said mobile client being operable for instructing said mobile computing device to present a plurality of payment instruments available for a selected financial transaction for the user to select a one of said plurality of payment instruments where said plurality of payment instruments are stored in a mobile wallet in said mobile computing device, said mobile client being operable for instructing said mobile computing device to communicate to said server at least information associated with said selected contact, said selected financial transaction and said selected payment instrument, said mobile client being operable for instructing said mobile computing device to receive results of said selected financial transaction from said sever and display said results for the user.

2. The system as recited in claim 1, in which said plurality of contacts comprises contact information for public and private entities.

3. The system as recited in claim 2, in which said entities comprises individuals and organizations.

4. The system as recited in claim 1, in which at least one of said contacts comprises an email address restricted to financial transactions.

5. The system as recited in claim 1, in which said mobile wallet comprises storage for payment instruments comprising electronic versions of credit cards, debit cards, gift cards, prepaid cards, flexible spending account cards and payment providers.

6. The system as recited in claim 5, in which one or more of said payment instruments comprises an electronic version of a card with identifying information that changes periodically via synchronization with an associated financial establishment.

7. The system as recited in claim 1, in which said mobile client is further operable for instructing said mobile computing device to communicate with a mobile gift store when the user selects a contact to receive a gift.

8. The system as recited in claim 1, in which said mobile computing device is further configured to be operable to store a contact obtained from communication with a local entity on the network region where said obtained contact is only available for financial transactions when said mobile computing device is able to communicate with said local entity.

9. The system as recited in claim 8, in which said obtained contact is removed from storage when communication with said local entity is unavailable.

10. The system as recited in claim 1, in which said mobile client is further operable for instructing said mobile computing device to receive one or more bills for payment by the user.

11. The system as recited in claim 1, in which the user selects a plurality of contacts with which to commence a financial transaction.

12. A system comprising:
means for mobile computing and communicating over a network region and a global network;
means for receiving and processing financial transaction information, performing financial transactions and receiving results of performed financial transactions, said receiving and processing means communicating, over the global network, with said mobile computing and communicating means and the network region; and
means for instructing said mobile computing and communicating means to present a plurality of contacts available for a user to select at least a one of said plurality of contacts with which to commence a financial transaction where said contacts are stored in said mobile computing and communicating means, said instructing means instructing said mobile computing and communicating means to present a plurality of financial transactions available for a selected contact for the user to select a one of said plurality of financial transactions where said plurality of financial transactions are stored in said mobile computing and communicating means, said instructing means instructing said mobile computing and communicating means to present a plurality of payment instruments available for a selected financial transaction for the user to select a one of said plurality of payment instruments where said plurality of payment instruments are stored in a mobile wallet in said mobile computing and communicating means, said instructing means instructing said mobile computing and communicating means to communicate to said receiving and processing means at least information associated with said selected contact, said selected financial transaction and said selected payment instrument, said instructing means instructing said mobile computing and communicating means to receive results of said selected financial transaction from said receiving and processing means and display said results for the user.

13. A method comprising the steps of:
a mobile client communicating with a network region and a global network;
said mobile client presenting a plurality of contacts available for a user to select at least a one of said plurality of contacts with which to commence a financial transaction, said contacts being stored in a mobile computing device;
said mobile client presenting a plurality of financial transactions available for a selected contact for the user to select a one of said plurality of financial transactions, said plurality of financial transactions being stored in said mobile computing device;
said mobile client presenting a plurality of payment instruments available for a selected financial transaction for the user to select a one of said plurality of payment instruments, said plurality of payment instruments being stored in a mobile wallet in said mobile computing device;
said mobile client communicating with a server in communication with the global network;
said mobile client transmitting at least information associated with said selected contact, said selected financial transaction and said selected payment instrument to said server where said server receives and processes said information, performs said selected financial transaction, receives results of said selected financial transaction from said selected contact, processes said results and transmits said results to said mobile client;
said mobile client receiving said results from said sever; and
said mobile client displaying said results for the user.

14. The method as recited in claim 13, in which said plurality of contacts comprises contact information for public and private entities.

15. The method as recited in claim 14, in which said entities comprises individuals and organizations.

16. The method as recited in claim 13, in which at least one of said contacts comprises an email address restricted to financial transactions.

17. The method as recited in claim 13, in which said mobile wallet comprises storage for payment instruments comprising electronic versions of credit cards, debit cards, gift cards, prepaid cards, flexible spending account cards and payment providers.

18. The method as recited in claim 17, in which one or more of said payment instruments comprises an electronic version of a card with identifying information that changes periodically via synchronization with an associated financial establishment.

19. The method as recited in claim 13, further comprising the step of said mobile client communicating with a mobile gift store when the user selects a contact to receive a gift.

20. The method as recited in claim 13, in which said mobile computing device is configured to be operable to store a contact obtained from communication with a local entity on the network region where said obtained contact is only available for financial transactions when said mobile computing device is able to communicate with said local entity.

21. The method as recited in claim 20, in which said obtained contact is removed from storage when communication with said local entity is unavailable.

22. The method as recited in claim 13, further comprising the step of said mobile client receiving one or more bills for payment by the user.

23. The method as recited in claim 13, in which the user selects a plurality of contacts with which to commence a financial transaction.

24. A method comprising:
steps for communicating with a network region and a global network;
steps for receiving one or more bills for payment by a user;
steps for presenting a plurality of contacts available for the user to select at least a one of said plurality of contacts with which to commence a financial transaction;
steps for presenting a plurality of financial transactions available for a selected contact for the user to select a one;
steps for presenting a plurality of payment instruments available for a selected financial transaction for the user to select a one;
steps for communicating with a mobile gift store when the user selects a contact to receive a gift;
steps for communicating with a server in communication with the global network;
steps for transmitting information to said server where said server receives and processes said information, performs said selected financial transaction, receives results of said selected financial transaction from said selected contact, processes said results and transmits said results to said mobile client;
steps for receiving said results from said sever; and
steps for displaying said results for the user.

25. A non-transitory program storage device readable by a machine tangibly embodying a program of instructions executable by the machine to perform a method for mobile financial transactions, comprising:
computer code for communicating with a network region and a global network;
computer code for presenting a plurality of contacts available for a user to select at least a one of said plurality of contacts with which to commence a financial transaction, said contacts being stored in a mobile computing device;
computer code for presenting a plurality of financial transactions available for a selected contact for the user to select a one of said plurality of financial transactions, said plurality of financial transactions being stored in said mobile computing device;
computer code for presenting a plurality of payment instruments available for a selected financial transaction for the user to select a one of said plurality of payment instruments, said plurality of payment instruments being stored in a mobile wallet in said mobile computing device;
computer code for communicating with a server in communication with the global network;
computer code for transmitting at least information associated with said selected contact, said selected financial transaction and said selected payment instrument to said server where said server receives and processes said information, performs said selected financial transaction, receives results of said selected financial transaction from said selected contact, processes said results and transmits said results;
computer code for receiving said results from said sever; and
computer code for displaying said results for the user.

26. The non-transitory program storage device as recited in claim 25, in which said plurality of contacts comprises contact information for public and private entities.

27. The non-transitory program storage device as recited in claim 26, in which said entities comprises individuals and organizations.

28. The non-transitory program storage device as recited in claim 25, in which at least one of said contacts comprises an email address restricted to financial transactions.

29. The non-transitory program storage device as recited in claim 25, in which said mobile wallet comprises storage for payment instruments comprising electronic versions of credit cards, debit cards, gift cards, prepaid cards, flexible spending account cards and payment providers.

30. The non-transitory program storage device as recited in claim 29, in which one or more of said payment instruments comprises an electronic version of a card with identifying information that changes periodically via synchronization with an associated financial establishment.

31. The non-transitory program storage device as recited in claim 25, further comprising computer code for communicating with a mobile gift store when the user selects a contact to receive a gift.

32. The non-transitory program storage device as recited in claim 25, in which said mobile computing device is configured to be operable to store a contact obtained from communication with a local entity on the network region where said obtained contact is only available for financial transactions when said mobile computing device is able to communicate with said local entity.

33. The non-transitory program storage device as recited in claim 32, in which said obtained contact is removed from storage when communication with said local entity is unavailable.

34. The non-transitory program storage device as recited in claim 25, further comprising computer code for receiving one or more bills for payment by the user.

35. The non-transitory program storage device as recited in claim 25, in which the user selects a plurality of contacts with which to commence a financial transaction.
